(19) United States
(12) Patent Application Publication
(10) Pub. No.: US 2007/0057889 A1
(43) Pub. Date: Mar. 15, 2007

(54) Method for Applying Detecting Circuits of Active-Matrix Organic Light Emitting Diode

(76) Inventors: Wen-Kuo Chu, Taipei City (TW); Bao-Jen Ann, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/379,222

(22) Filed: Apr. 18, 2006

(30) Foreign Application Priority Data
Sep. 15, 2005 (TW) 094131915

(51) Int. Cl. G09G 3/36

(52) U.S. Cl. 345/92

(57) ABSTRACT

Detecting statuses of driving units of an active-matrix organic light emitting diode (AMOLED) may reveal defects in the manufacturing process. This helps to detect and remove defective elements earlier in the manufacturing process before forming luminous layers in an AMOLED so as to decrease loss of organic materials and manufacturing time, and to increase yield significantly in the later part of the manufacturing process. The tested AMOLED includes a plurality of voltage sources, a plurality of pixel electrodes, and a plurality of driving units corresponding to the pixel electrodes respectively. Each driving unit includes a first TFT, a second TFT, and a storage capacitor. Defective elements of each driving unit can be detected by checking the detection results.

### BACKGROUND OF THE INVENTION

1. Field of the Invention

The present invention relates to a method for applying detecting circuits, and more particularly to a method for applying detecting circuits of an active-matrix organic light emitting diode.

2. Description of the Prior Art

Please refer to FIG. 1 showing a diagram of an AMOLED having pixel electrodes and being suitable for detection of a TFT-element matrix, which was published by IBM JAPAN during the 10th International Display Workshop that was held in 2003 (IDW '03). As shown in FIG. 1, a pixel circuit 500 of the TFT-element matrix comprises a first transistor 501, a snubber capacitor (Cs) 503 having one terminal electrically connected to the drain of the first transistor 501, a second transistor 505 having a gate electrically connected to the drain of the first transistor 501 and the terminal of the snubber capacitor 503, an organic light emitting diode 507 having an anode electrically connected to the source of the second transistor 505, and a third transistor 509 having a drain electrically connected to the source of the second transistor 505 and the anode of the organic light emitting diode 507, wherein the second transistor 505 is a thin film transistor used for driving a circuit, and the third transistor 509 is a bypass thin film transistor. The pixel circuit 500 tests whether the working status of the second transistor 505 is normal with the third transistor 509, a bypass control electrically connected to the gate of the third transistor 509, and a ground (GND) electrically connected to the source of the third transistor 509. Therefore, the organic light emitting diode 507 can be operated normally with the second transistor 505. Although the design is capable of detecting whether a second transistor 505 works normally, it still cannot be determined which second transistor 505 of the TFT-element matrix has malfunctioned. Furthermore, the third transistor 509 is additionally added to the pixel circuit 500 for assisting the detection so that the aperture ratio of the TFT-element matrix is decreased.

Please refer to FIG. 2, which is a diagram for determining whether a TFT element is working by adding additional current meters. As shown in FIG. 2, the active-matrix organic light emitting diode (AMOLED) 600 comprises a first thin film transistor 601, a storage capacitor 603 having one terminal electrically connected to the drain of the first thin film transistor 601, a second thin film transistor 605 having a gate electrically connected to the drain of the first thin film transistor 601, and an organic light emitting diode 607 having an anode electrically connected to the source of the second thin film transistor 605. In FIG. 2, there are further a set of testing apparatuses comprising a first current meter 609 electrically connected to the drain of the second thin film transistor 605, a first voltage source 611 electrically connected to the first current meter 609, a second current meter 613 electrically connected to the cathode of the organic light emitting diode 607, a second voltage source 615 electrically connected to the second current meter 613, a writing circuit 617 having two outputs electrically connected respectively to the gate and the source of the first thin film transistor 601, and a decision element 619 electrically connected to the first current meter 609, wherein the writing circuit 617 is used for writing a binary signal, and the decision element 619 is used for determining whether the statuses of each elements of the active-matrix organic light emitting diode 600 are normal according to the readings of the first current meter 609 and the second current meter 613. Although the device mentioned in this patent works in theory, however, since the intensity of the bias current applied by the active-matrix organic light emitting diode 600 is too low for both the first current meter 609 and the second current meter 613 to detect the readings of tiny currents so that normal elements may be regarded as malfunctioned elements.

Please refer to FIG. 3, which is a top view for performing an illumination determination in a short-circuit situation by using conductive rubbers after finishing manufacturing an AMOLED and before connecting the AMOLED to a driving integrated circuit. As shown in FIG. 3, an organic light emitting diode panel 700 comprises a plurality of display regions 701, a plurality of conductive plates 703, and a plurality of conductive rubbers 705 each sticking between a display region 701 and a conductive plate 703. With disposition of the conductive rubbers 705, the organic light emitting diode panel 700 is capable of resisting larger voltages and currents, and is capable of finding out defective elements before finishing forming the whole driving circuit for saving losses of defective driving circuits. However, the organic light emitting diode panel 700 is not capable of saving losses of replacing materials of organic light emitting diodes. The organic light emitting diode panel 700 is also not able to save manufacturing time.

### SUMMARY OF THE INVENTION

Therefore, an object of the present invention is to provide a method for applying detecting circuits of an active-matrix organic light emitting diode to solve the aforementioned problems.

The present invention discloses a method for applying detecting circuits of an active-matrix organic light emitting diode comprises providing a pixel electrode, providing a driving unit comprising a first transistor, a second transistor electrically connected to the first transistor and the pixel electrode, and a capacitor electrically connected to the first transistor and the second transistor, and detecting a potential difference between one terminal and another terminal of the capacitor when the first transistor is switched on and the second transistor is switched off.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art AMOLED having pixel electrodes and being suitable for detection of a TFT-element matrix.

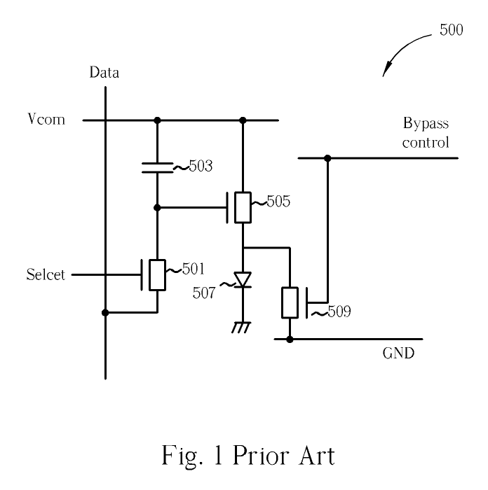

FIG. 2 is a diagram for determining whether a TFT element is working by adding additional current meters according to the prior art.

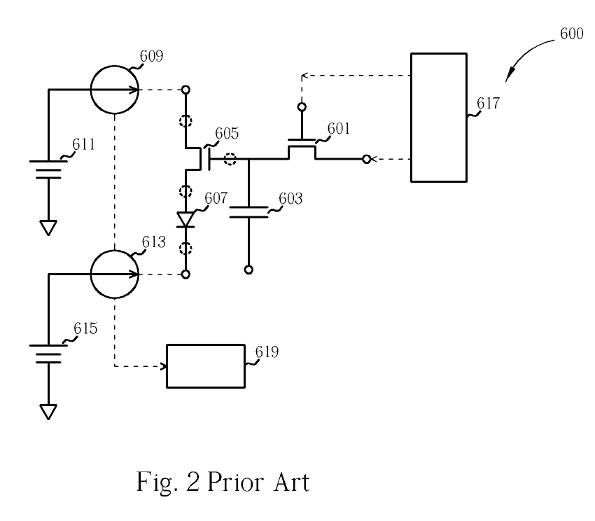

FIG. 3 is a top view for performing an illumination determination in a short-circuit situation by using conductive rubbers after finishing manufacturing an AMOLED and before connecting the AMOLED to a driving integrated circuit according to the prior art.

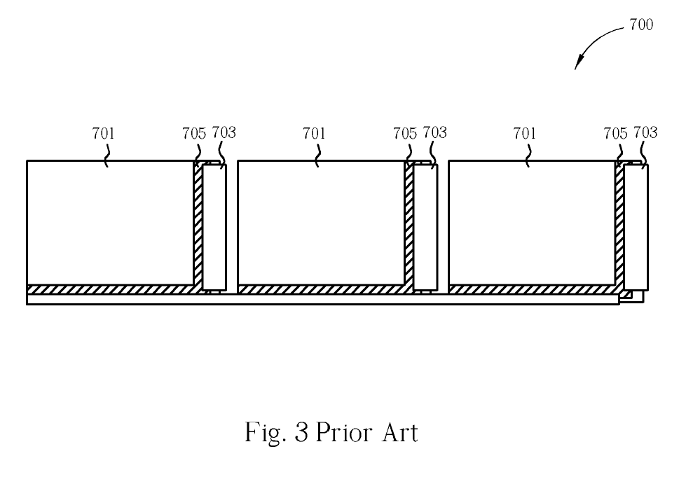

FIG. 4 is a diagram of a first embodiment of an AMOLED for performing the detecting method of the present invention.

FIG. 5 is a flowchart for detecting a status of the AMOLED of FIG. 4.

FIG. 6 is a diagram of a second embodiment of an AMOLED for performing the detecting method of the present invention.

FIG. 7 is a flowchart for detecting a status of the AMOLED of FIG. 6.

FIG. 8 is a diagram of an equivalent circuit of each driving unit of the present invention when each second transistor of each driving unit is switch off.

FIG. 9 is a diagram of an equivalent circuit of each driving unit of the present invention while detecting a status of each second transistor and each pixel electrode corresponding to each driving unit with a non-contact detecting device.

FIG. 10 is a diagram of input pulses of each voltage source while detecting the status of the second transistor and the pixel electrode with a non-contact detecting device of FIG. 9.

### DETAILED DESCRIPTION

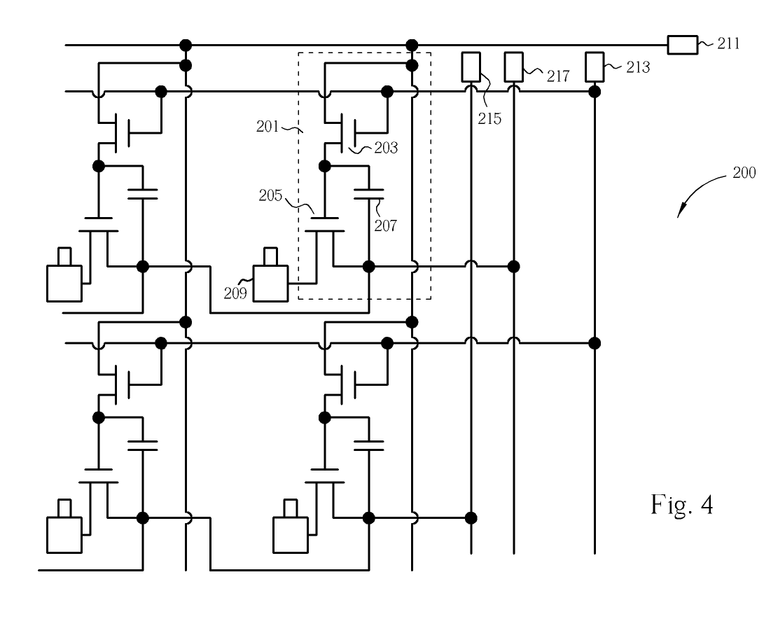

Please refer to FIG. 4, which is a diagram of a first embodiment of an AMOLED 200 for executing the detecting method of the present invention. The AMOLED 200 comprises a plurality of driving units 201, a plurality of pixel electrodes 209, a data voltage source 211, a gate voltage source 213, a first voltage source 215 for providing voltage to odd pixels, and a second voltage source 217 for providing voltage to even pixels. Each driving unit 201 comprises a first transistor 203, a second transistor 205, and a storage capacitor 207. In each driving unit 201, the second transistor 205 is electrically connected to the first transistor 203 and the pixel electrode 209 corresponding to the driving unit 201. The storage capacitor 207 has a first terminal electrically connected to the first transistor 203 and the second transistor 205. Each pixel electrode 209 is an OLED, wherein its current provision is manipulated by the second transistor 205 of the corresponding driving unit 201. Each pixel electrode 209 can be an odd-pixel electrode or an even-pixel electrode according to various positions of its corresponding driving unit 201 inside AMOLED 200. The data voltage source 211 is electrically connected to the drain of the first transistor 203 of each driving unit 201. The gate voltage source 213 is electrically connected to the gate of the first transistor 203 of each driving unit 201. The first voltage source 215 is electrically connected to the drain of the second transistor 205 and a second terminal of the storage capacitor 207 of each driving unit 201 corresponding to each pixel electrode 209 that is an odd-pixel electrode. The second voltage source 217 is electrically connected to the drain of the second transistor 205 and the second terminal of the storage capacitor 207 of each driving unit 201 corresponding to each pixel electrode 209 that is an even-pixel electrode.

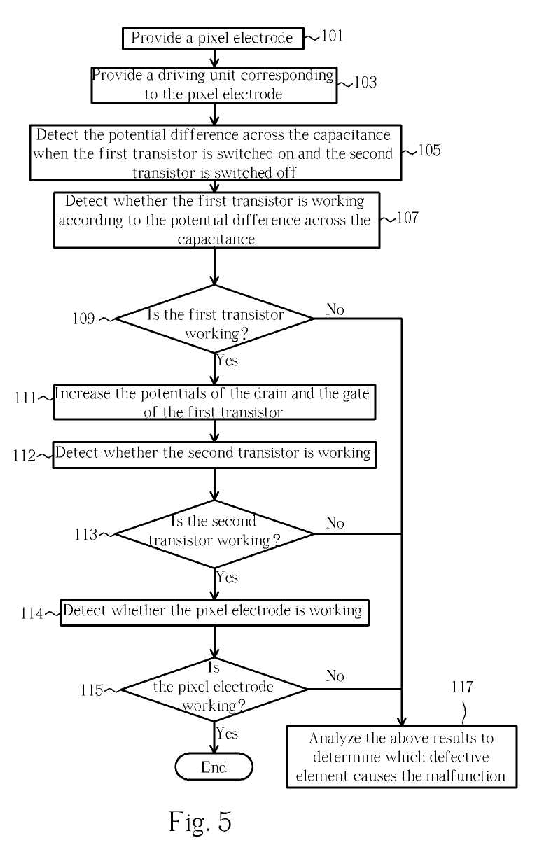

Please refer to FIG. 5, which is a flowchart for detecting a status of the AMOLED 200. The steps are as follows:

Step 101: provide a pixel electrode 209;

Step 103: provide a driving unit 201 corresponding to the pixel electrode 209;

Step 105: detect a potential difference across the storage capacitor 207 when the first transistor 203 is switched on and the second transistor 205 is switched off;

Step 107: detect whether the first transistor 203 is working according to the potential difference across the storage capacitor 207;

Step 109: if the first transistor 203 is working, perform Step 111; otherwise, perform Step 117;

Step 111: increase the potentials of the drain and the gate of the first transistor 203;

Step 112: detect whether the second transistor 205 is working;

Step 113: if the second transistor 205 is working, perform Step 114; otherwise, perform Step 117;

Step 114: detect whether the pixel electrode 209 is working;

Step 115: if the pixel electrode 209 is working, end the procedure; otherwise, perform Step 117; and

Step 117: analyze the above results to determine malfunction of which suspected element caused the defect, wherein the suspected elements include the first transistor 203, the second transistor 205, and the pixel electrode 209.

The pixel electrode 209 provided in Step 101 can be an odd-pixel electrode or an even-pixel electrode in the AMOLED 200 and is diagramed in FIG. 4.

The driving unit 201 provided in Step 103 is the fundamental unit while performing the method in the AMOLED 200 and is diagramed in FIG. 4. The method for detecting is capable of being performed simultaneously in each driving unit 201 inside the AMOLED 200 to report whether defects happen among the elements inside the AMOLED 200 in a shortest time and to analyze the defects.

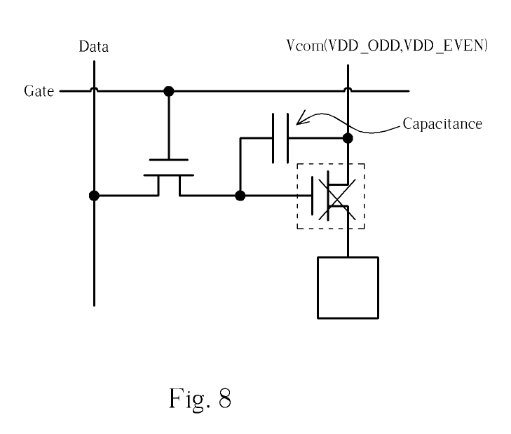

In Steps 105 and 107, a standard voltage Vcom is inputted into the first voltage source 215 or the second voltage source 217 in the AMOLED 200 to make each second transistor 205 switch off. At this time, the equivalent circuit of each driving unit 201 is shown in FIG. 8. After switching on the first transistor 203 by a probe-contact detecting machine, determining whether the first transistor 203 is malfunctioning in the manufacturing process, and calculating the electric quantity of the storage capacitor 207, the related results are stored as a basis for later analysis. The malfunctions of the transistors of the present invention include malfunction of nodes or wires.

In Step 109, if first transistor is malfunctioning, the situation is stored and reported in Step 117 to serve as a basis for determining which element is malfunctioning in the manufacturing process.

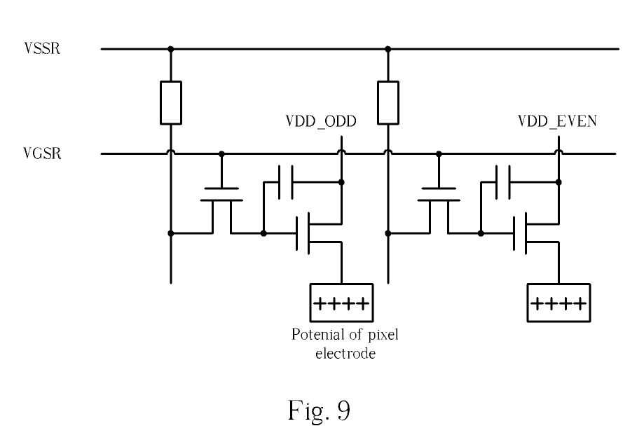

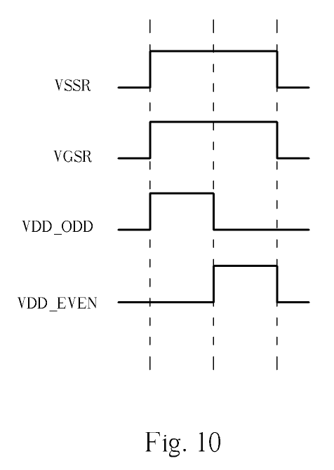

In Step 109, if the first transistor 203 is working, then a data voltage VSSR and a gate voltage VGSR are inputted into the data voltage source 211 and the gate voltage source 213 respectively in Step 111 so that the storage capacitor 207 is charged by the first transistor 203 until the second transistor 205 is switched on. Then a testing voltage VDD_ODD is inputted into the first voltage source 215, and a testing voltage VDD_EVEN is inputted into the second voltage source 217 so that each pixel electrode 209 electrically connected to the first voltage source 215 or the second voltage source 217 is charged. A non-contact detecting device is used to determine whether there are any defects in the manufacturing process of the second transistor 205 and the pixel electrode 209 by way of photoelectron transduction or secondary electron collection and to store the related results of detection. Please refer to FIG. 9, which is a diagram of the equivalent circuit of each driving unit 201 while detecting a status of the second transistor 205 and the pixel electrode 209 corresponding to the driving unit 201 with a non-contact detecting device. Please refer to FIG. 10, which is a diagram of input pulses of each voltage source while detecting a status of the second transistor 205 and the pixel electrode 209 with the non-contact detecting device of FIG. 9.

In Steps 113 and 115, if there are no defects in the manufacturing process, then the procedure is ended to process procedures of the untested AMOLEDs 200. If there is any defect found in Step 113 or 115, the result of the defect is stored and reported as a basis for determining which element is malfunctioning.

In Step 117, the stored results about defects in Steps 109, 113, 115 are analyzed together to determine the precise positions of the malfunctioning elements in the AMOLED 200. The method is also capable of simultaneously detecting defects of a plurality of the driving units 201 in the AMOLED 200. So the method is not limited to detecting one defect at a time.

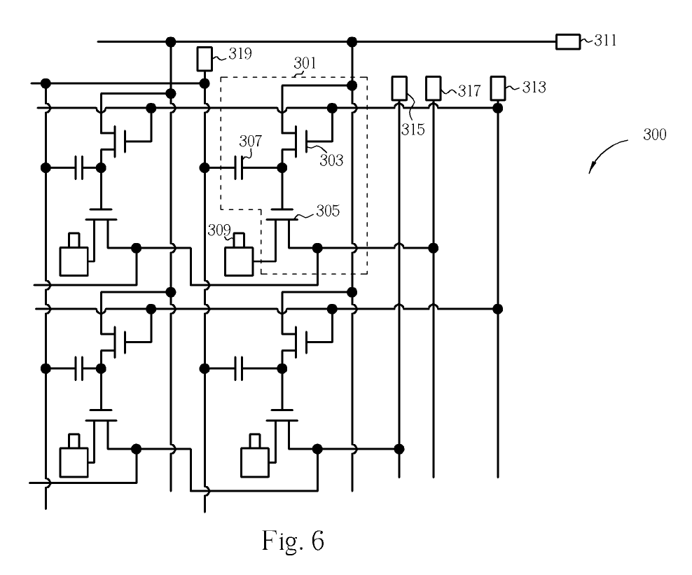

Please refer to FIG. 6, which is a diagram of a second embodiment AMOLED 300 for performing the detecting method of the present invention. The AMOLED 300 comprises a plurality of the driving units 301, a plurality of pixel electrode 309, a data voltage source 311, a gate voltage source 313, a first voltage source 315 for providing voltage to odd pixels, a second voltage source 317 for providing voltage to even pixels, and a third voltage source 319. Each driving unit 301 comprises a first transistor 303, a second transistor 305, and a storage capacitor 307. In each driving unit 301, the second transistor 305 is electrically connected to the first transistor 303 and the pixel electrode 309 corresponding to the driving unit 301. The storage capacitor 307 has a first terminal electrically connected to the first transistor 303 and the second transistor 305. Each pixel electrode 309 is an OLED, wherein its current is manipulated by the second transistor 305 of the corresponding driving unit 301. Each pixel electrode 309 can be an odd-pixel electrode or an even-pixel electrode according to the various positions of the corresponding the driving unit 301 inside the AMOLED 300. The data voltage source 311 is electrically connected to the drain of the first transistor 303 of each driving unit 301. The gate voltage source 313 is electrically connected to the gate of the first transistor 303 of each driving unit 301. The first voltage source 315 is electrically connected to the drain of the second transistor 305 of each driving unit 301 corresponding to each pixel electrode 309 that is an odd-pixel electrode. The second voltage source 317 is electrically connected to the drain of the second transistor 305 and the storage capacitor 307 of each driving unit 301 corresponding to each pixel electrode 309 that is an even-pixel electrode. The third voltage source 319 is electrically connected to the storage capacitor 307. The differences between the AMOLED 300 and the AMOLED 200 are the position of the storage capacitor 307 and the addition of the third voltage source 319. In the AMOLED 200, a second terminal of the storage capacitor 207 is electrically connected to the first voltage source 215 or the second voltage source 217 while a second terminal of the storage capacitor 307 is electrically connected to the additional third voltage source 319 instead of the first voltage source 315 or the second voltage source 317 in the AMOLED 300. The different arrangements in the AMOLED 200 and the AMOLED 300 are caused by the storage capacitor 307, which is not a discrete element. The storage capacitor 307 is formed by the structure of the driving unit 301 or between insulation layers inside the driving unit 301. Therefore, usage of space and the cost of a discrete storage capacitor can be saved, however, the bias voltage of the storage capacitor 307 may be significantly unstable so that there are likely to be inaccurate potentials on elements inside the driving unit 301. Therefore, a third voltage source 319 is electrically connected to the second terminal of the storage capacitor 307 in the AMOLED 300 so that a standard voltage is provided to the storage capacitor 307 and the bias voltage of the storage capacitor 307 becomes stable. Because of the stable bias voltage of the storage capacitor 307, the degree of inaccuracy of potentials on elements inside the driving unit 301 is decreased so that all driving units 301 inside the AMOLED 300 are not affected.

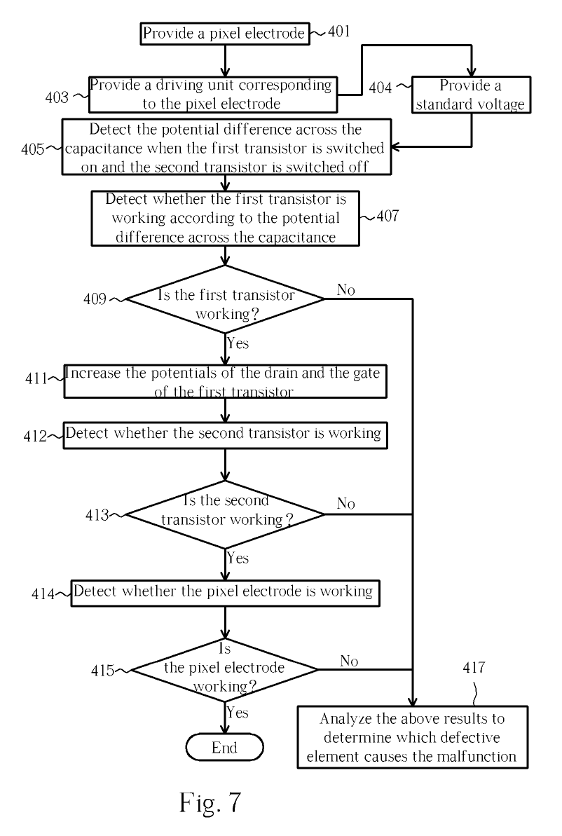

Please refer to FIG. 7, which is a flowchart for detecting a status of the AMOLED 300 in FIG. 6. The steps are as follows:

Step 401: provide a pixel electrode 309;

Step 403: provide a driving unit 301 corresponding to the pixel electrode 309;

Step 404: input a standard voltage Vcom into the third voltage source 319 for providing the standard voltage Vcom to the storage capacitor 307;

Step 405: detect the potential difference across the storage capacitor 307 when the first transistor 303 is switched on and the second transistor 305 is switched off;

Step 407: detect whether the first transistor 303 is working according to the potential difference across the storage capacitor 307;

Step 409: if the first transistor 303 is working, perform Step 411; otherwise, perform Step 417;

Step 411: increase the potentials of the drain and the gate of the first transistor 303;

Step 412: detect whether the second transistor 305 is working;

Step 413: if the second transistor 305 is working, perform Step 414; otherwise, perform Step 417;

Step 414: detect whether the pixel electrode 309 is working;

Step 415: if the pixel electrode 309 is working, end the procedure; otherwise, perform Step 417; and

Step 417: analyze the above results to determine malfunction of which suspected element caused the defect, wherein the suspected elements include the first transistor 303, the second transistor 305, and the pixel electrode 309.

The pixel electrode 309 provided in Step 401 can be an odd-pixel electrode or an even-pixel electrode in the AMOLED 300 and is diagramed in FIG. 6.

The driving unit 301 provided in Step 403 is the fundamental unit for performing the method and is also shown in FIG. 6. The method for detecting is capable of being performed simultaneously in each driving unit 301 inside the AMOLED 300 to quickly report whether defects occur among the elements of the AMOLED 300 and to analyze such defects.

In Step 404, the reason for inputting a standard voltage in the third voltage source 319 is the structure of the storage capacitor 307. The detected results can be affected by the inaccuracy of the bias voltage of the storage capacitor 307. Therefore the standard voltage Vcom is provided so that the detecting results are not affected by the inaccuracy of bias voltage of the storage capacitor 307. The above problems have been described above in conjunction with FIG. 6 and are not explained further here.

In Steps 405 and 407, a standard voltage Vcom is inputted into the first voltage source 315 or the second voltage source 317 in the AMOLED 300 to make each second transistor 305 switch off. At this time, the equivalent circuit of each driving unit 301 is shown in FIG. 8, wherein the equivalent circuit is the same as for the driving unit 201. After switching on the first transistor 303 by a probe-contact detecting machine, determining whether the first transistor 303 is malfunctioning in the manufacturing process, and calculating the electric quantity of the storage capacitor 307, the related results are stored as a basis for later analysis. Possible malfunctions of transistors include malfunction of nodes or wires.

In Step 409, if first transistor is malfunctioning, the situation is stored and reported in Step 417 to serve as a basis for determining which element is malfunctioning in the manufacturing process.

In Step 409, if the first transistor 303 is working, then a data voltage VSSR and a gate voltage VGSR are inputted into the data voltage source 311 and the gate voltage source 313 respectively in Step 411 so that the storage capacitor 307 is charged by the first transistor 303 until the second transistor 305 is switched on. Then a testing voltage VDD_ODD is inputted into the first voltage source 315, and a testing voltage VDD_EVEN is inputted into the second voltage source 317 so that each pixel electrode 209 electrically connected to the first voltage source 315 or the second voltage source 317 is charged. A non-contact detecting device determines whether there are any defects in the manufacturing process of the second transistor 305 and the pixel electrode 309 by ways of photoelectron transduction or secondary electron collection and stores the related results of detection. Please refer to FIG. 9, which is a diagram of the equivalent circuit of each driving unit 301 that is the same as the equivalent circuit of each driving unit 201, while detecting a status of the second transistor 305 and the pixel electrode 309 corresponding to the driving unit 301 with a non-contact detecting device. Please refer to FIG. 10, which is a diagram of input pulses of each voltage source while detecting a status of the second transistor 305 and the pixel electrode 309 with the non-contact detecting device of FIG. 9, wherein the input pulses of each voltage source are the same as in the AMOLED 200.

In Steps 413 and 415, if there are no defects in the manufacturing process, then the procedure is ended to process procedures of the untested AMOLEDs 300. If there is any defect found in Step 413 or 415, the result of the defect is stored and reported as a basis for determining which element is malfunctioning.

In Step 417, the stored results about defects in Step 409, 413, 415 are analyzed together to know the precise positions of malfunctioning elements in the AMOLED 300 well. The method is also capable of detecting defects of a plurality of the driving units 301 in the AMOLED 300 at one time. So the method is not limited to detecting one defect at a time.

The AMOLED of the prior art is not capable of precisely determining whether the TFT elements inside each driving unit are working since the luminance layers of OLEDs have not been formed after forming a TFT-element matrix (also called a driving-unit matrix). The present invention takes advantage of available detecting devices to detect malfunctioned elements earlier in the manufacturing process so that yield of the manufacturing process is improved, and the loss of manufacturing time is decreased. Another advantage of the present invention is that the aperture ratio is not increased since additional TFT elements are not added into AMOLEDs. Moreover, malfunctioned elements are identified by available detecting devices so that the cost of devices is not increased. Combining detecting results of a probe-contact detecting device and a non-contact detecting device, the first transistor of an AMOLED (e.g. the switching TFT) is tested for defects including short circuit, open circuit, and malfunction of nodes. The second transistor (e.g. the driving TFT) is tested for OLED illumination. Furthermore, image processing can also be used to determine the uniformity of properties of the elements and detecting a plurality of malfunctioned elements precisely in the element matrix of an AMOLED.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for applying detecting circuits of an active-matrix organic light emitting diode, comprising:
providing a pixel electrode;
providing a driving unit, the driving unit comprising a first transistor, a second transistor electrically connected to the first transistor and the pixel electrode, and a capacitor electrically connected to the first transistor and the second transistor; and
detecting a potential difference between one terminal and another terminal of the capacitor when the first transistor is switched on and the second transistor is switched off.

2. The method of claim 1, further comprising detecting the first transistor according to the potential difference between one terminal and another terminal of the capacitor.

3. The method of claim 1, further comprising a potential of a drain of the first transistor and a potential of a gate of the first transistor are increased after detecting the first transistor according to the potential difference between one terminal and another terminal of the capacitor.

4. The method of claim 3, further comprising detecting the second transistor after increasing the potential of the drain of the first transistor and the potential of the gate of the first transistor.

5. The method of claim 4, wherein detecting the second transistor comprises detecting the second transistor by performing photoelectric conversion.

6. The method of claim 4, wherein detecting the second transistor comprises detecting the second transistor by collecting secondary electrons.

7. The method of claim 4, further comprising detecting the pixel electrode.

8. The method of claim 7, wherein detecting the pixel electrode comprises detecting the pixel electrode by performing photoelectric conversion.

9. The method of claim 7, wherein detecting the pixel electrode comprises detecting the pixel electrode by collecting secondary electrons.

10. A detecting circuit used for the method of claim 1, comprising:
a plurality of driving units;
a plurality of pixel electrodes comprising a plurality of odd pixel electrodes and a plurality of even pixel electrodes, wherein each pixel electrode electrically connected to a corresponding driving unit;
a data voltage source electrically connected to the plurality of driving units;
a gate voltage source electrically connected to the plurality of driving units;
a first voltage source electrically connected to driving units corresponding to the odd pixel electrodes; and
a second voltage source electrically connected to driving units corresponding to the even pixel electrodes.

11. The detecting circuit of claim 10, wherein each of the plurality of driving units comprises:
a first transistor having a drain electrically connected to the data voltage source and having a gate electrically connected to the gate voltage source;
a second transistor having a gate electrically connected to a source of the first transistor and having a source electrically connected to a pixel electrode of the detecting circuit; and
a storage capacitor having a first terminal electrically connected to the source of the first transistor and the gate of the second transistor.

12. The detecting circuit of claim 11, wherein the pixel electrode is an odd pixel electrode, and the first voltage source is electrically connected to a second terminal of the storage capacitor and the drain of the second transistor.

13. The detecting circuit of claim 11, wherein the pixel electrode is an even pixel electrode, and the second voltage source is electrically connected to a second terminal of the storage capacitor and the drain of the second transistor.

14. A detecting circuit used for the method of claim 1, comprising:
a plurality of driving units;
a plurality of pixel electrodes comprising a plurality of odd pixel electrodes and a plurality of even pixel electrodes, each pixel electrode corresponding to a driving unit;
a data voltage source electrically connected to the plurality of driving units;
a gate voltage source electrically connected to the plurality of driving units;
a first voltage source electrically connected to driving units corresponding to the odd pixel electrodes;
a second voltage source electrically connected to driving units corresponding to the even pixel electrodes; and
a third voltage source electrically connected to the plurality of driving units.

15. The detecting circuit of claim 14, wherein each of the plurality of the driving units comprises:
a first transistor having a drain electrically connected to the data voltage source and having a gate electrically connected to the gate voltage source;
a second transistor having a gate electrically connected to a source of the first transistor and having a source electrically connected to a pixel electrode of the detecting circuit; and
a storage capacitor having a first terminal electrically connected to the source of the first transistor and the gate of the second transistor and having a second terminal electrically connected to the third voltage source.

16. The detecting circuit of claim 15, wherein the pixel electrode is an odd pixel electrode, and the first voltage source is electrically connected to the drain of the second transistor.

17. The detecting circuit of claim 15, wherein the pixel electrode is an even pixel electrode, and the second voltage source is electrically connected to the drain of the second transistor.
